(19) United States
(12) Patent Application Publication
(10) Pub. No.: US 2025/0209508 A1
(43) Pub. Date: Jun. 26, 2025

(54) SYSTEMS AND METHODS FOR CUSTOMIZING PERSONALIZATION SETTINGS FOR A USER

(71) Applicant: Wells Fargo Bank, N.A., San Francisco, CA (US)

(72) Inventors: Scott Best, Charlotte, NC (US); Ling Yee Lindy Sin, San Francisco, CA (US); Praveen Kesani, San Ramon, CA (US); Frank Digangi, Charlotte, NC (US)

(21) Appl. No.: 18/395,920

(22) Filed: Dec. 26, 2023

(51) Int. Cl. G06Q 30/0601

(52) U.S. Cl. CPC G06Q 30/0621

(57) ABSTRACT

Systems, apparatuses, methods, and computer program products are disclosed for customizing personalization settings for a user. An example method includes receiving initiating event data and generating a first output. The example method further includes determining a target setting from the personalization settings and a target setting recommendation and generating a conversation prompt providing information about the target setting recommendation. The example method further includes presenting the conversation prompt to the user and receiving a user response. The example method further includes generating a second output and updating the target setting recommendation. The example method further includes, in an instance in which executing the target setting recommendation requires modifying the personalization settings, presenting updated personalization settings to the user and, in an instance in which the user confirms the updated personalization settings, updating the personalization settings according to the target setting recommendation.

### BACKGROUND

Digital products and services frequently rely on collecting personal data from customers to provide a highly personalized user experience. Products and services typically must obtain permission from users to collect personal data, and obtaining this permission may require a specific user interface. Furthermore, users may have trouble ensuring that the permissions they have chosen to grant various digital products and services are in line with their desired level of comfort.

### BRIEF SUMMARY

With the rise in availability of hyper-personalized products and services from all sectors, consumers may be hesitant to make certain purchases or perform certain activities due to privacy concerns. Customers may avoid engaging or reduce engagement with certain platforms altogether to avoid perceived privacy infringements. At the same time, customers may have privacy preferences that vary based on sectors or domains of activity, such that in some segments (but perhaps not all) a customer would prefer the tradeoff of reduced privacy in exchange for improved convenience of product recommendations, rewards, or other personalized benefits.

Current standard solutions may involve a high degree of complexity but sacrifice ease of use and transparency, which may dissuade customers from setting privacy controls in their preferred mode.

In contrast to these conventional techniques for personalization, example embodiments described herein give customers the ability to control how or when algorithms personalize content for them. Example embodiments present several ways to provide personalization feedback, including both a conversational, human experience that is contextual and tailored, and a fallback option that centers on a traditional graphical user interface with buttons and sliders to control personalization mechanics in detail.

The conversational experience may use a language model to interact with a customer to provide a more tailored and contextual experience. The model may use data already known about the customer, combined with the customer's current state of mind, to engage and build a relationship with the customer. As an example, a customer may log into a mobile application and be greeted with a personalized message from the language model. The user may share relevant information, for example, related to savings goals. The language model may pass this information to relevant systems and, determining that personalization settings would need to be adjusted to recommend appropriate products, follow up with a question asking the customer if they would agree to make the needed personalization setting changes to enable making offers tailored to the customer's savings goals.

In the fallback option, the user interface elements that enable sharing of data for recommending certain products may be set, and the customer may manually update privacy and/or personalization settings using this interface. The fallback option may fully reflect any changes made in the conversational or language model mode. Privacy settings may also be timely, contextual, and/or temporary as preferred by the customer. For example, a customer may wish to make a series of transactions at vendors they would not normally visit in order to shop for gifts, and may want to avoid seeing future recommendations related to the particular vendor or type of purchase. In this instance, the customer may direct the language model assistant to ignore, for the purpose of product personalization, purchases made from the particular vendor, at a particular time of day, or when specifically requested, and instead may make particular purchases in a high-privacy mode.

Furthermore, example embodiments disclosed herein may utilize similar pathways to enhance personalized products in addition to personalization settings. For example, the tailored user experience using the language model may collect information including emotional inputs from the user to provide or improve existing spending reports, liquidity models, fund projections, and/or the like. Example embodiments may capture initiating event data related to these and other example applications, for example, a change in spending patterns, market shifts, and/or the like, and subsequently generate language model output to develop a plan of action in conversation with a user. The user response to the language model output may target one or more settings in the application, for example, by adjusting investment or liquidity strategies and/or the like.

Additionally, example embodiments may accumulate a recorded history of settings changes in response to various conditions and user preferences, and this recorded history may provide an improvement to the user's experience. Certain settings or changes may be determined to apply in a recurring manner. For example, a user may update certain personalization settings once a year when preparing taxes or preparing end-of-year reports, then may revert settings back to “normal” operation. Example embodiments may also record and document the complete evolution and history of a user's settings and changes to meet reporting guidelines for quality control and/or regulatory requirements.

Accordingly, the present disclosure sets forth systems, methods, and apparatuses that improve the personalization and customization experience for users of digital products and services. There are many advantages of these and other embodiments described herein. For instance, improving the user interface to personalization settings may enable users to access more finely-grained settings than would be practical with existing methods. Presenting a complex personalization setting scheme to a user via a traditional graphical user interface may be too complex to practically make available. The technical implementations set forth herein solve this technical problem inherent to existing digital privacy control regimes. In addition, example embodiments may incentivize customers to undertake certain beneficial behaviors. Example embodiments may present hypothetical scenarios as incentives, for example, if a particular setting is enabled, a certain discount or offer may become available as a result. Seeing the clear connection between personalization settings and incentives may benefit the customer and the provider of digital products and services.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for customizing personalization settings for a user.

FIG. 2 illustrates a schematic block diagram of example circuitry embodying a system device that may perform various operations in accordance with some example embodiments described herein.

FIG. 3A illustrates an example flowchart for customizing personalization settings for a user, in accordance with some example embodiments described herein.

FIG. 3B illustrates another example flowchart for customizing personalization settings for a user, in accordance with some example embodiments described herein.

FIG. 4 illustrates another example flowchart for determining and updating a profile setting, in accordance with some example embodiments described herein.

FIG. 5 illustrates another example flowchart for retrieving initial event information, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “initiating event” refers to a signal or process that is received by an example apparatus and may directly or indirectly trigger the process of updating personalization and/or privacy settings. Initiating events may be directly initiated by the user, for example, by selecting an option in a graphical user interface that causes a change in personalization settings. In some embodiments, initiating events may be a user response to an earlier prompt or event. For example, a mobile application may provide a notification to a user with an offer that requires a change in personalization settings, and the user may cause an initiating event by interacting with the notification of the mobile application. In some embodiments, the initiating event may be caused automatically by example systems when certain conditions are met. For example, the example system may detect a change in a user's credit score, a major life event, or a change in interest rates, which may cause the system to check for potential initiating events. The initiating event data may be formatted as natural language, suitable to be interpreted by a language model of example systems disclosed herein.

The system may then cause an initiating event if the change in conditions is determined to be relevant to personalization and/or privacy settings customization. The determination of conditions and their relevance to the personalization and/or privacy settings may be performed using a rule-based system, a machine learning approach, or other models. In some embodiments, circuitry of the apparatus 200 may continuously or routinely monitor customer data, global data such as news or financial events, bank information, geographical (location) information, or the like, to determine when an initiating event may be generated.

The term “profile setting” refers to a pre-determined collection of personalization and/or privacy settings that may be fixed, determined by the user, and/or automatically determined according to certain parameters. For example, a “privacy mode” or “incognito mode” profile may be available which disables the storage or collection of all personal information while the profile is in effect. As another example, a “sandbox” or “silo” profile may enable certain settings temporarily while holding all collected information only in association with the particular profile. Profile settings may be specified by users for various purposes, for example a profile setting may be formed for vacationing, for traveling to certain destinations, or for certain family members who may share payment or account details. Profile settings may also be formed for professional or business purposes to keep certain details separate from personal use.

### System Architecture

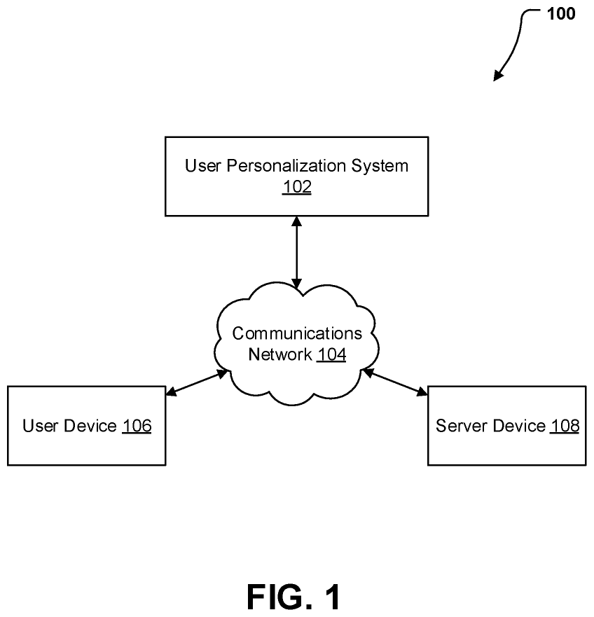

Example embodiments described herein may be implemented using any of a variety of computing devices or servers. To this end, FIG. 1 illustrates an example environment 100 within which various embodiments may operate. As illustrated, a user personalization system 102 may receive and/or transmit information via communications network 104 (e.g., the Internet) with any number of other devices, such as one or more of user device 106 and/or server device 108.

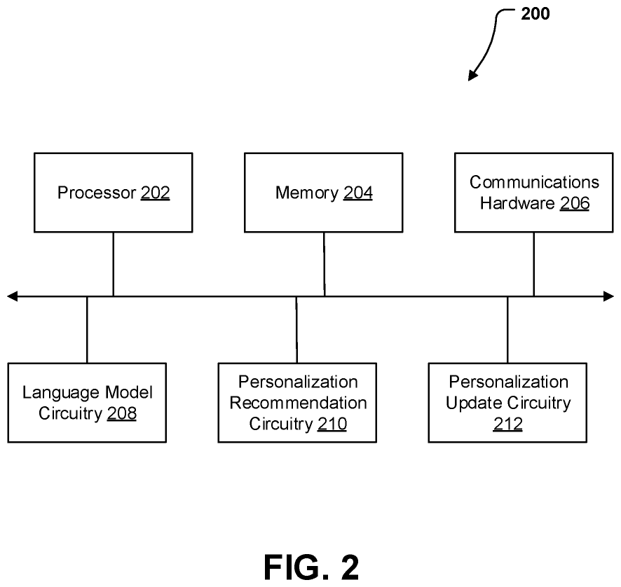

The user personalization system 102 may be implemented as one or more computing devices or servers, which may be composed of a series of components. Particular components of the user personalization system 102 are described in greater detail below with reference to apparatus 200 in connection with FIG. 2.

The user device 106 and the server device 108 may be embodied by any computing devices known in the art. The user device 106 and the server device 108 need not themselves be independent devices, but may be peripheral devices communicatively coupled to other computing devices. Although a single user device 106 and a single server device 108 are depicted in FIG. 1, it will be understood that additional user devices and/or server devices may be in communication with the user personalization system 102 via communications network 104.

Although FIG. 1 illustrates an environment and implementation in which the user personalization system 102 interacts indirectly with a user via user device 106 and/or server device 108, in some embodiments users may directly interact with the user personalization system 102 (e.g., via communications hardware of the user personalization system 102), in which case a separate user device 106 and/or server device 108 may not be utilized. Whether by way of direct interaction or indirect interaction via another device, a user may communicate with, operate, control, modify, or otherwise interact with the user personalization system 102 to perform the various functions and achieve the various benefits described herein.

### Example Implementing Apparatuses

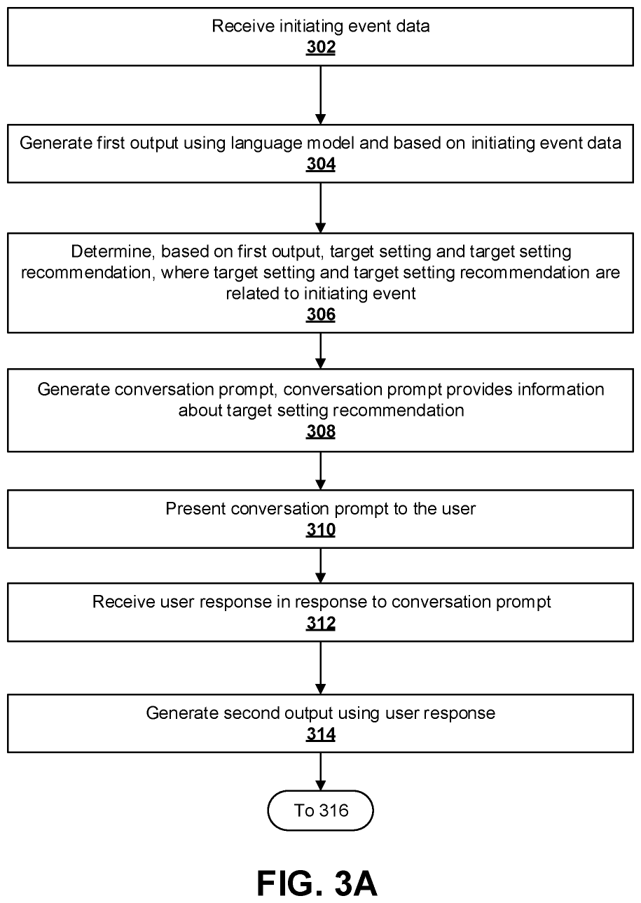

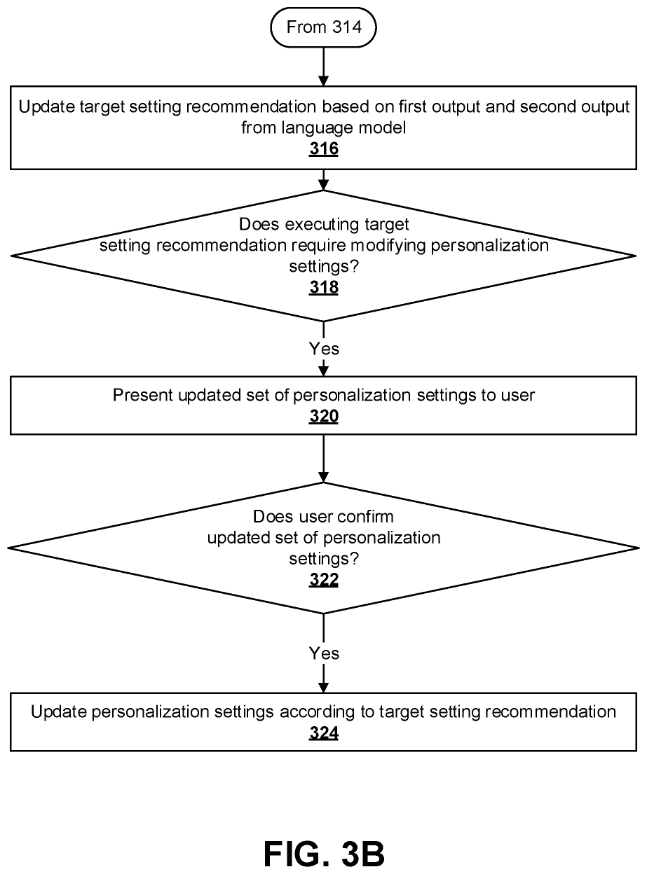

The user personalization system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3A-5. As illustrated in FIG. 2, the apparatus 200 may include processor 202, memory 204, communications hardware 206, language model circuitry 208, personalization recommendation circuitry 210, and personalization update circuitry 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a language model circuitry 208 that generates language model output using initiating event data, generates a conversation prompt for a user, and generates language model output in response to a user response. The language model circuitry 208 may utilize processor 202, memory 204, or any other hardware component included in the apparatus 200 to perform these operations, as described in connection with FIGS. 3A-5 below. The language model circuitry 208 may further utilize communications hardware 206 to gather data from a variety of sources (e.g., user device 106 or server device 108, as shown in FIG. 1), and/or exchange data with a user, and in some embodiments may utilize processor 202 and/or memory 204 to process language inputs and outputs.

The language model circuitry 208 may include one or more language models, such as large language models. For example, in embodiments in which the language model is a large language model, the language model circuitry 208 may a large dataset including a database. An initiating event may include the initialization or updating of the database, which may trigger the user personalization system 102 to receive an initiating event via the communications hardware 206. For example, enterprise or organization-based users may possess large stores of data that may be incorporated into a large language model to automatically trigger the operations depicted in FIG. 3 for management of organizational privacy and personalization settings.

In addition, the apparatus 200 further comprises a personalization recommendation circuitry 210 that determines a target setting from a set of personalization settings based on outputs from a language model and updates target settings and target setting recommendations based on outputs from the language model. The personalization recommendation circuitry 210 may utilize processor 202, memory 204, or any other hardware component included in the apparatus 200 to perform these operations, as described in connection with FIGS. 3A-5 below. The personalization recommendation circuitry 210 may further utilize communications hardware 206 to gather data from a variety of sources (e.g., user device 106 or server device 108, as shown in FIG. 1), and/or exchange data with a user, and in some embodiments may utilize processor 202 and/or memory 204 to process personalization settings from language model outputs.

Further, the apparatus 200 further comprises a personalization update circuitry 212 that updates personalization settings according to a target setting recommendation. The personalization update circuitry 212 may utilize processor 202, memory 204, or any other hardware component included in the apparatus 200 to perform these operations, as described in connection with FIGS. 3A-5 below. The personalization update circuitry 212 may further utilize communications hardware 206 to gather data from a variety of sources (e.g., user device 106 or server device 108, as shown in FIG. 1), and/or exchange data with a user, and in some embodiments may utilize processor 202 and/or memory 204 to execute changes to personalization settings.

Although components 202-212 are described in part using functional language, it will be understood that the particular implementations necessarily include the use of particular hardware. It should also be understood that certain of these components 202-212 may include similar or common hardware. For example, the language model circuitry 208, personalization recommendation circuitry 210, and personalization update circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the language model circuitry 208, personalization recommendation circuitry 210, and personalization update circuitry 212 may leverage processor 202, memory 204, or communications hardware 206 as described above, it will be understood that any of language model circuitry 208, personalization recommendation circuitry 210, and personalization update circuitry 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that language model circuitry 208, personalization recommendation circuitry 210, and personalization update circuitry 212 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of flowcharts.

### Example Operations

Turning to FIGS. 3A-5, example flowcharts are illustrated that contain example operations implemented by example embodiments described herein. The operations illustrated in FIGS. 3A-5 may, for example, be performed by the user personalization system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, language model circuitry 208, personalization recommendation circuitry 210, personalization update circuitry 212, and/or any combination thereof. It will be understood that user interaction with the user personalization system 102 may occur directly via communications hardware 206, or may instead be facilitated by a separate user device 106, as shown in FIG. 1, and which may have similar or equivalent physical componentry facilitating such user interaction.

Turning first to FIG. 3A, example operations are shown for customizing a set of personalization settings for a user. As shown by operation 302, the apparatus 200 includes means, such as processor 202, memory 204, communications hardware 206, or the like, for receiving initiating event data regarding an initiating event, where receiving the initiating event data is enabled based on a setting from the set of personalization settings.

The initiating event may be a signal or process that is received by communications hardware 206 or other circuitry of the apparatus 200 and may directly or indirectly trigger the process of updating personalization and/or privacy settings. Initiating events may be directly initiated by the user, for example, by selecting an option in a graphical user interface that causes a change in personalization settings. In some embodiments, initiating events may be a user response to an earlier prompt or event. For example, a mobile application may provide a notification to a user with an offer that requires a change in personalization settings, and the user may cause an initiating event by interacting with the notification of the mobile application. In some embodiments, the initiating event may be caused automatically by the user personalization system 102 when certain conditions are met. For example, the user personalization system 102 may detect a change in a user's credit score, a major life event, or a change in interest rates, which may cause the system to check for potential initiating events. The initiating event data may be formatted as natural language, suitable to be interpreted by a language model of the user personalization system 102.

In some embodiments, the initiating event may derive from a database. For example, in embodiments in which the language model circuitry comprises a large language model (e.g., the language model is a large language model), the language model circuitry 208 may ingest a large dataset including a database. The initiating event may include the initialization or updating of the database, which may trigger the user personalization system 102 to receive an initiating event via the communications hardware 206. For example, enterprise or organization-based users may possess large stores of data that may be incorporated into a large language model to automatically trigger the operations depicted in FIG. 3 for management of organizational privacy and personalization settings.

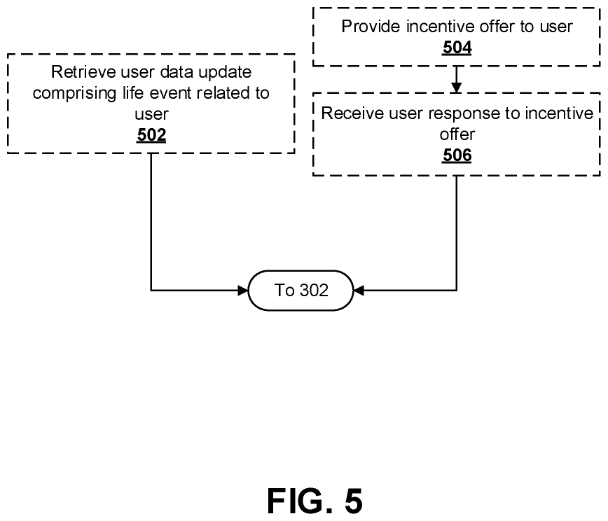

The user personalization system 102 may then cause an initiating event if the change in conditions is determined to be relevant to personalization and/or privacy settings customization. The determination of conditions and their relevance to the personalization and/or privacy settings may be performed using a rule-based system, a machine learning approach, or other models. In some embodiments, circuitry of the apparatus 200 may continuously or routinely monitor customer data, global data such as news or financial events, bank information, geographical (location) information, or the like, to determine when an initiating event may be generated. Further details regarding some example methods of generating initiating event information are described below in connection with FIG. 5.

In some embodiments, the user personalization system 102 may cause initiating events if a change in conditions is determined to be relevant to other specified applications (e.g., other than personalization and/or privacy settings). For example, the user personalization system 102 may be configured to provide updates to expense reporting, liquidity management systems, fund projections, and/or the like.

As shown by operation 304, the apparatus 200 includes means, such as processor 202, memory 204, communications hardware 206, language model circuitry 208, or the like, for generating, using the initiating event data, a first output using natural language processing, ingesting the initiating event data to interpret the initiating event data. The language model circuitry 208 may additionally use information retrieval methods to summarize, filter, and determine the relevant information from the initiating event data. The language model circuitry 208 may process the initiating event data through the language model to produce a compact data object summarizing the relevant parts. The compact data object may be used to generate the first output. The compact data object and/or the first output may be data in any format, such as plain text, formatted markup text such as XML or JSON, binary data, or the like. The first output may include the relevant data in a format that may be interpreted directly by the personalization recommendation circuitry for determining personalization recommendations.

As shown by operation 306, the apparatus 200 includes means, such as processor 202, memory 204, personalization recommendation circuitry 210, or the like, for determining, based on the first language model output, a target setting from the set of personalization settings and a target setting recommendation. The target setting and the target setting recommendation may be related to the initiating event. The personalization recommendation circuitry 210 may receive the first output from the language model, which may include information regarding the initiating event that has been interpreted, filtered, and otherwise processed to a format that is able to be interpreted. In some embodiments, the memory 204 may maintain a database of available personalization and privacy settings together with various products, services, offers, incentives, or the like that relate to each personalization or privacy setting. The personalization recommendation circuitry 210 may use a rules based approach or other algorithms to determine, from the first language model output, one or more personalization and/or privacy settings that relate to the initiating event. The personalization recommendation circuitry 210 may provide one or more of the identified settings as the target setting. The personalization recommendation circuitry 210 may further consider the user's current personalization and/or privacy settings together with the related settings to determine a target setting recommendation, where the target setting recommendation may be one of the potential states of the target setting.

In some embodiments, the personalization recommendation circuitry 210 may determine a target setting relevant to other specified applications (e.g., other than personalization and/or privacy settings). For example, the personalization recommendation circuitry 210 may determine target settings to personalize expense reporting, liquidity management systems, fund projections, and/or the like based on the initiating event.

As shown by operation 308, the apparatus 200 includes means, such as processor 202, memory 204, language model circuitry 208, or the like, for generating, using the language model, a conversation prompt. The conversation prompt may provide information about the target setting recommendation. The language model circuitry 208 may generate or use a language model to generate the conversation prompt as a text-based communication in the user's language relating to the initiating event data. Subsequent processes may present the text to the user, or prepare synthesized speech, video, or other media to present the generated language model output. The conversation prompt may be seeded or prompted based on the initiating event information, with additional context provided by the language model circuitry 208 to produce desirable language outputs. The conversation prompt may be additionally seeded, or developed with additional information from the target setting and/or the target setting recommendation. The language model circuitry 208 may augment the language model abilities of the one or more language models to act as an artificial intelligence agent.

In some embodiments, the language model circuitry 208 may further use recorded information from past interactions with a user to develop the conversation prompt. For example, the language model circuitry 208 may evolve a language model over time by including the history of user interactions and their subsequent setting changes, labeling each interaction and weighting successful interactions. Furthermore, certain past interactions may be made recurring, such as an annual setting change for tax or year-end reporting purposes.

For example, the initiating event data may be user data indicating that a customer may have plans to save for college (e.g., based on spending history, location history, or the like). The initiating event, with the target setting and target setting recommendation (e.g., a recommendation to enable automatically rounding up purchases into savings with each payment card purchase) to generate a personalized, human-like conversation prompt. For example, conversation prompt may include, “I noticed you are starting to think about saving for college, I can accelerate your plans if you would like to enable automatic savings with each card payment.” The conversation prompt may then be subsequently processed using one or more quality control processes to ensure the conversation prompt meets a confidence level threshold, where the confidence level threshold may be a pre-determined value. The quality control step may prevent poorly-formed conversation prompts that may be generated in rare occasions by the language model from being presented to the user. For example, the language model circuitry 208 may provide the conversation prompt to the processor 202 or other circuitry where the quality control step may be performed. The processor 202 may execute a trained discriminator model using the conversation prompt as input, where the trained model may provide a numerical measure of the conversation prompt quality to distinguish preferable, high quality prompts from poor prompts. The trained discriminator model may be trained, for example, to penalize poor grammar, unnatural sentence construction, vulgarity, or other undesirable responses. The numerical measure may be compared to a threshold value, and the conversation prompt may be re-generated if the threshold value is not met.

As shown by operation 310, the apparatus 200 includes means, such as processor 202, memory 204, communications hardware 206, or the like, for presenting the conversation prompt to the user. The communications hardware 206 may receive the conversation prompt from the language model circuitry 208 and present the conversation prompt to the user via any of several modes. For example, the conversation prompt may appear as a mobile application notification as text, as a video or audio synthetic voice sample, as a text popup in a web browser, or other examples. The communications hardware 206 may provide the conversation prompt to an external user device 106, attached hardware, or other devices. In some embodiments, the conversation prompt may be presented in combination with conversation prompts from other sources, or conversation prompts may be aggregated, processed, or transformed before finally being presented to the user.

As shown by operation 312, the apparatus 200 includes means, such as processor 202, memory 204, communications hardware 206, or the like, for receiving a user response in response to the conversation prompt. The communications hardware 206 may receive the response to the conversation prompt having presented the conversation prompt to the user in example operation 310. The response to the conversation prompt may be received via the communications hardware 206 using any of several modes. For example, the user may reply using text input, video, or audio (which may be subsequently interpreted as text). The text input may be received as input by the user in a user interface, for example, in a web browser, or any other text input mode. The communications hardware 206 may receive the response via an external user device 106, attached hardware, or other devices. In some embodiments, the response to the conversation prompt may be received in combination with other user combinations, aggregated, processed, or transformed before finally being returned for subsequent operations.

While example operations may describe a single conversation prompt and user response to the conversation prompt, it will be understood by one skilled in the art that multiple such interactions between conversation prompts and users may occur. Subsequent conversation prompts may clarify or limit the user response, or may gather additional information not found in the initial response.

As shown by operation 314, the apparatus 200 includes means, such as processor 202, memory 204, communications hardware 206, language model circuitry 208, or the like, for providing, by the language model circuitry, the user response to the language model, wherein the language model provides a second output. As described previously, the language model circuitry 208 may use a language model to generate a second output using natural language processing, ingesting and interpreting the user response to the conversation prompt. The language model circuitry 208 may process the user response to the conversation prompt through the language model to produce a compact data object summarizing the information in machine-readable form. The compact data object may be used to generate the second output. The compact data object and/or the second output may be data in any format, such as plain text, formatted markup text such as XML or JSON, binary data, or the like. The second output may include the processed data in a format that may be interpreted directly by the personalization recommendation circuitry for determining personalization recommendations.

Turning now to FIG. 3B, continued example operations are shown for customizing a set of personalization settings for a user. As shown by operation 316, the apparatus 200 includes means, such as processor 202, memory 204, communications hardware 206, personalization recommendation circuitry 210, or the like, for updating the target setting recommendation based on the first output and the second output from the language model. In some embodiments, the personalization recommendation circuitry 210 may analyze the first output and the second output to determine if an update to the target setting and/or target setting recommendation is necessary. In an instance in which the second output includes a confirmation of the information presented to the user based on the first output, the personalization recommendation circuitry 210 may not alter the target setting or target setting recommendation. In an instance in which the second output includes updated information from the user, for example, if the user rejects the proposed personalization setting update but suggests a different setting in response, or forms a reply that suggests a different target setting may be desirable, the personalization recommendation circuitry 210 may update the target setting based on the second output in line with the example.

In some embodiments, the second output may indicate that further information should be collected from the user to determine the target setting and/or target setting recommendation. For example, the personalization recommendation circuitry 210 may not reach a required level of confidence after analyzing the first output and/or the second output from the language model. In an instance in which the determination is made that additional information is needed from the user, the personalization recommendation circuitry 210 may return to the language model circuitry 208 to construct another conversation prompt, and may continue to collect information from the user in line with operation 308 through operation 316 until a sufficient level of confidence is reached from the language model outputs.

As shown by decision block 318, the example method may depend on whether executing the target setting recommendation requires modifying personalization settings. If executing the target setting recommendation does require modifying personalization settings, the example method may proceed to operation 320. In some embodiments, if executing the target setting recommendation does not require modifying personalization settings, the target setting recommendation may be executed silently, without notifying or without requiring input from a user. In some embodiments, if executing the target setting recommendation does not require modifying personalization settings, the example method may end without executing any changes to the personalization settings.

As shown by operation 320, the apparatus 200 includes means, such as processor 202, memory 204, communications hardware 206, or the like, for presenting an updated set of personalization settings to the user. The updated set of personalization settings may include the target setting and the target setting recommendation. The communications hardware 206 may receive the updated set of personalization settings from the personalization recommendation circuitry 210 and present the settings to the user via any of several modes. For example, the updated settings may appear as text in a chat interface, or may appear as a graphical representation, for example, in a personalization settings user interface. In some embodiments, the language model circuitry 208 may provide a conversational presentation of the set of personalization settings, which may be in turn presented in a similar manner as described above (e.g., text notification, voice or video, or the like). The communications hardware 206 may provide the updates set of personalization settings to an external user device 106, attached hardware, or other devices. In some embodiments, the updated set of personalization settings may be presented in combination with conversation prompts from other sources, or conversation prompts may be aggregated, processed, or transformed before finally being presented to the user.

The updated set of personalization settings may be presented in a way so that the user may confirm or cancel the proposed updated set of personalization settings. For example, a dialog box may ask the user to proceed or cancel, or a conversation prompt may be provided, with the user responding in the affirmative or negative in a natural language response.

In some embodiments, the target setting and/or target setting recommendation may be presented in isolation to the user, or in some embodiments all related personalization and/or privacy settings may be presented to the user. In some embodiments, a user interface may be presented together with the updated set of personalization settings where the user may make changes to any of the available personalization and/or privacy settings concurrently with the target setting, and the user may set any of these settings to any desired value.

As shown by decision block 322, the example method may depend on whether the user confirms the updated set of personalization settings. If the user confirms the updated set of personalization settings, the example method may proceed to operation 324. In some embodiments, if the user does not confirm the updated set of personalization settings, the example method may end without executing any changes to the personalization settings.

As shown by operation 324, the apparatus 200 includes means, such as processor 202, memory 204, communications hardware 206, personalization update circuitry 212, or the like, for updating the set of personalization settings according to the target setting recommendation. The personalization update circuitry 212 may maintain a record of personalization and/or privacy settings, and may access the appropriate setting corresponding to the target setting. The personalization update circuitry 212 may adjust the target setting to the value corresponding to the target setting recommendation. For example, the personalization and/or privacy settings may be stored as a dictionary of key and value pairs. The personalization update circuitry 212 may access the setting based on the key matching the target setting, and set the corresponding value to the target setting recommendation.

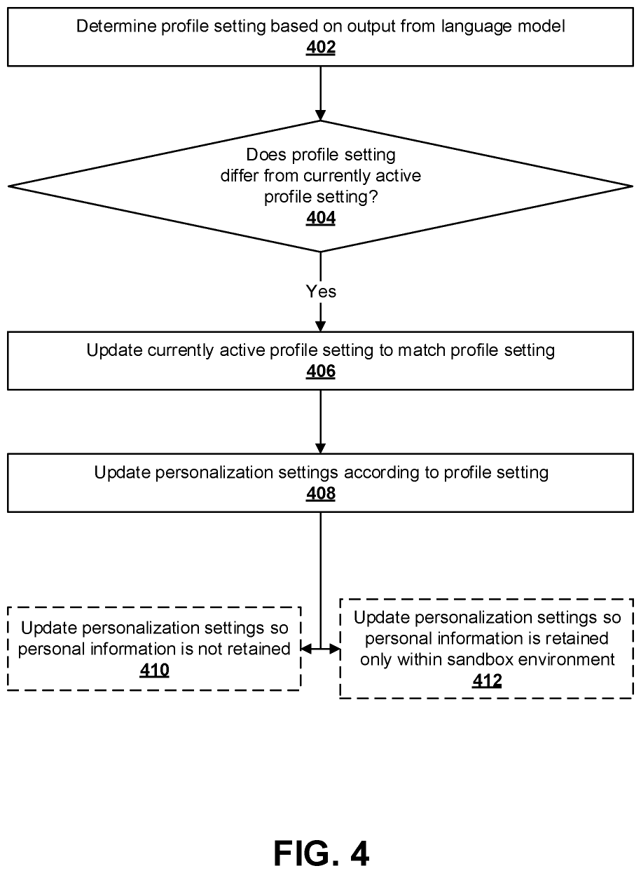

Turning now to FIG. 4, example operations are shown for determining and updating a profile setting. As shown by operation 402, the apparatus 200 includes means, such as processor 202, memory 204, communications hardware 206, personalization recommendation circuitry 210, or the like, for determining a profile setting based on the first output and the second output from the language model circuitry 208 (e.g., the language model). The profile setting may determine the set of personalization settings by selecting among a plurality of sets of personalization settings.

The profile setting may be a pre-determined collection of personalization and/or privacy settings that may be fixed, determined by the user, and/or automatically determined according to certain parameters. For example, a “privacy mode” or “incognito mode” profile may be available which disables the storage or collection of all personal information while the profile is in effect. As another example, a “sandbox” or “silo” profile may enable certain settings temporarily while holding all collected information only in association with the particular profile. Profile settings may be specified by users for various purposes, for example a profile setting may be formed for vacationing, for traveling to certain destinations, or for certain family members who may share payment or account details. Profile settings may also be formed for professional or business purposes to keep certain details separate from personal use.

The personalization recommendation circuitry 210 may analyze the first output and the second output from the language model to determine if a profile setting is involved in the user's request and/or the initiating event. In some instances, the personalization recommendation circuitry 210 may interpret a direct request from the user to apply a profile setting, while in some instances, the personalization recommendation circuitry 210 may infer or suggest the creation or activation of a profile based on circumstances. For example, the personalization recommendation circuitry 210 may identify that a user frequently changes certain related settings, and may suggest creating one or more profiles that may automatically activate under certain conditions. The personalization recommendation circuitry 210 may include transaction history, geolocation history, or other relevant user data in the profile setting recommendations or decisions. For example, the personalization recommendation circuitry 210 may suggest that a user create a new profile after observing that certain settings are modified while visiting a particular city.

As shown by decision block 404, the example method may depend on whether the profile setting differs from the currently active profile setting. If the profile setting does differ from the currently active profile setting, the example method may proceed to operation 406. In some embodiments, if the profile setting is the same as the currently active profile setting, no further operations related to profile settings may be needed, and the operations depicted in FIG. 4 may end.

As shown by operation 406, the apparatus 200 includes means, such as processor 202, memory 204, communications hardware 206, personalization update circuitry 212, or the like, for updating the currently active profile setting to match the profile setting. The personalization update circuitry 212 may store in memory 204 or other storage an indication of the currently active profile setting. The personalization update circuitry 212 may update the indication of the currently active profile setting to match the profile setting as determined, for example, in operation 402.

As shown by operation 408, the apparatus 200 includes means, such as processor 202, memory 204, communications hardware 206, personalization update circuitry 212, or the like, for updating the set of personalization settings according to the profile setting. The personalization update circuitry 212 may apply the profile setting to update the set of personalization settings by retrieving the set of personalization settings associated with the profile setting, for example, from memory 204. The personalization update circuitry may use the retrieved personalization settings associated with the profile setting and update the set of personalization settings accordingly. In some embodiments, the personalization update circuitry 212 may temporarily store the existing set of personalization settings to enable the system to undo the personalization settings update, or may cause associated circuitry to prompt the user to save the previous set of personalization settings as a profile to avoid losing the settings. Operations 410 and 412 illustrate examples of ways that the apparatus 200 may update the personalization settings based on a profile setting.

As shown by operation 410, the apparatus 200 may include means, such as processor 202, memory 204, communications hardware 206, personalization update circuitry 212, or the like, for updating the set of personalization settings so that personal information is not retained. In some embodiments, this action may be taken by the personalization update circuitry 212 when the profile setting is an incognito profile setting. The personalization update circuitry 212 may detect the selection status of the incognito profile setting and, in an instance in which an incognito profile setting is selected, the personalization update circuitry 212 may update the set of personalization settings consistent with the incognito, or private profile, setting. The personalization update circuitry 212 may cause the set of personalization settings to be configured so that no personal information is retained, which may correspond to a maximum privacy configuration, or minimum information sharing. For example, the personalization update circuitry 212 may update the set of privacy settings to discard personal information regarding location, purchase history, communications, and the like except for that information which is essential to operation of other systems.

Finally, as shown by operation 412, the apparatus 200 may include means, such as processor 202, memory 204, communications hardware 206, personalization update circuitry 212, or the like, for updating the set of personalization settings so that personal information is retained only within a sandbox environment. In some embodiments, this action may be taken by the personalization update circuitry 212 when the profile setting is a sandbox profile setting. The personalization update circuitry 212 may detect the selection status of the sandbox profile setting and, in an instance in which a sandbox profile setting is selected, the personalization update circuitry 212 may update the set of personalization settings consistent with the sandbox, or silo, profile setting. The personalization update circuitry 212 may cause the set of personalization settings to be configured so that any personal information is only retained within a local or session-based instance. For example, the personalization update circuitry 212 may update the set of privacy settings to associate shared personal information only with the sandbox account. The user may request or prepare a report during a session that includes the personal information gathered in the sandbox profile. In some embodiments, the sandbox profile may retain the personal information only locally within the profile instance. In some embodiments, the sandbox profile may report personal information to external devices as usual, but may only associate the personal information reported with the sandbox profile. For example, the user may switch to a different sandbox profile and receive a different set of personalization information (e.g., purchasing recommendations or the like) that are not related to the original information collected in association with the sandbox profile.

Turning now to FIG. 5, example operations are shown for retrieving initial event information. As shown by operation 502, the apparatus 200 may include means, such as processor 202, memory 204, communications hardware 206, language model circuitry 208, personalization recommendation circuitry 210, or the like, for receiving a user data update, wherein the user data update comprises a life event related to the user. In some embodiments, the communications hardware may receive the initiating event data which may include details of the user data update. The language model circuitry 208 may case the language model to interpret the details of the user data update and parse structured information relating to the life event of the user. For example, the initiating event may include electronic communications from the user relating to college preparatory materials, web searches relating to college admissions, or the like. The initiating event data may include all relevant communications, user history, web searches, and the like which may be provided and received by the communications hardware 206 to be processed as the initiating event and associated initiating event data. In some embodiments, the operation of receiving the initiating event data based on a user life event may not require direct input from the user, but may be triggered upon detecting certain user data such as births, deaths, marriages, divorces, job changes, employment changes, address changes, or the like.

As shown by operation 504, the apparatus 200 may include means, such as processor 202, memory 204, communications hardware 206, or the like, for providing an incentive offer to the user, where the incentive offer is linked to the target setting recommendation. In some embodiments, the communications hardware may provide the incentive offer based on data received from an external source. In some embodiments, associated circuitry of the apparatus 200 (e.g., the language model circuitry 208, personalization recommendation circuitry 210) may generate the incentive offer based on one or more pre-determined parameters, user activity data, initiating event data, and/or the like. The communications hardware 206 may provide the incentive offer to the user, for example, through an associated user device 106. The communications hardware may cause the display of a push notification, an email, instant message, pop-up notification, or the like to convey the incentive offer. The incentive offer may be linked to the target setting recommendation, for example, by offering an incentive as a reward for accepting the target setting recommendation.

As shown by operation 506, the apparatus 200 may include means, such as processor 202, memory 204, communications hardware 206, or the like, for receiving a user response to the incentive offer. The user response may be received based on the incentive offer to the user, for example, in connection with operation 504. In some embodiments, the initiating event data may include the incentive offer and the user response to the incentive offer. The incentive offer and the user response to the incentive offer may accordingly be used to determine the target setting from the set of personalization settings (e.g., in connection with operation 306). The user response to the incentive offer may be a simple yes or no response, such as clicking or tapping an accept button on a push notification, or may be a more complex response, such as an interpreted voice response recorded by microphone hardware of the communications hardware 206. The incentive offer and the user response to the incentive offer may be structured together so that they may be provided together to other circuitry for subsequent operations (e.g., operation 306).

FIGS. 3A-5 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations described above in connection with FIGS. 3A-5 may be modified or further amplified. Furthermore, in some embodiments, additional optional operations may be included. Modifications, amplifications, or additions to the operations above may be performed in any order and in any combination.

### CONCLUSION

As described above, example embodiments provide methods and apparatuses that enable improved customization of personalization and privacy settings. Example embodiments thus provide tools that overcome the problems faced when designing digital products and services that require user consent to provide information needed to enable certain actions. Moreover, embodiments described herein avoid the complicated interfaces that users may find intimidating, which may deter users from enabling certain services and sharing data.

As these examples all illustrate, example embodiments contemplated herein provide technical solutions that solve real-world problems faced when offering digital products and services that leverage personal user data. And while digital privacy control has been an issue for decades, the recently exploding amount of data made available by recently emerging technology today has made this problem significantly more acute, as the demand for hyper-personalized content that leverages generative artificial intelligence has grown significantly even while the requirement for data to fuel these innovative hyper-personalized approaches has itself increased. At the same time, the recently arising ubiquity of generative artificial intelligence has unlocked new avenues to solving this problem that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for customizing a set of personalization settings for a user, the method comprising:
receiving, by communications hardware, initiating event data regarding an initiating event;
generating, by language model circuitry and using the initiating event data, a first output;
determining, by personalization recommendation circuitry and based on the first output, a target setting from the set of personalization settings and a target setting recommendation, wherein the target setting and the target setting recommendation are related to the initiating event;
generating, by language model circuitry, a conversation prompt, wherein the conversation prompt provides information about the target setting recommendation;
presenting, by the communications hardware, the conversation prompt to the user;
receiving, by the communications hardware and in response to the conversation prompt, a user response;
generating, by the language model circuitry and using the user response, a second output;
updating, by the personalization recommendation circuitry, the target setting recommendation based on the first output and the second output from the language model circuitry; and
in an instance in which executing the target setting recommendation requires modifying the set of personalization settings:
presenting, by the communications hardware, an updated set of personalization settings to the user, wherein the updated set of personalization settings comprises the target setting and the target setting recommendation, and
in an instance in which the user confirms the updated set of personalization settings, updating, by personalization update circuitry, the set of personalization settings according to the target setting recommendation.

2. The method of claim 1, further comprising:
determining, by the personalization recommendation circuitry and based on the first output and the second output from the language model circuitry, a profile setting, wherein the profile setting determines the set of personalization settings from among a plurality of sets of personalization settings.

3. The method of claim 2, further comprising, in an instance in which the profile setting differs from a currently active profile setting:
updating, by the personalization update circuitry, the currently active profile setting to match the profile setting; and
updating, by the personalization update circuitry, the set of personalization settings according to the profile setting.

4. The method of claim 2, wherein the profile setting is an incognito profile setting and the method further comprises:
detecting, by the personalization update circuitry, selection of the incognito profile setting; and
updating, by the personalization update circuitry, the set of personalization settings so that personal information is not retained.

5. The method of claim 2, wherein the profile setting is a sandbox profile setting, and the method further comprising:
detecting, by the personalization update circuitry, selection of the sandbox profile setting; and
updating, by the personalization update circuitry, the set of personalization settings so that personal information is retained only within a sandbox environment.

6. The method of claim 1, wherein the initiating event data derives from a database, wherein the language model circuitry comprises a large language model.

7. The method of claim 1, further comprising:
receiving, by the communications hardware, a user data update, wherein the user data update comprises a life event related to the user,
wherein the initiating event data comprises details of the user data update.

8. The method of claim 1, further comprising:
providing, by the communications hardware and to the user, an incentive offer, wherein the incentive offer is linked to the target setting recommendation; and
receiving, by the communications hardware, a user response to the incentive offer,
wherein the initiating event data comprises the incentive offer and the user response to the incentive offer.

9. An apparatus for customizing a set of personalization settings for a user, the apparatus comprising:
communications hardware configured to receive initiating event data regarding an initiating event;
language model circuitry configured to generate, using the initiating event data, a first output; and
personalization recommendation circuitry configured to determine, based on the first output, a target setting from the set of personalization settings and a target setting recommendation, wherein the target setting and the target setting recommendation are related to the initiating event,
wherein the language model circuitry is further configured to generate a conversation prompt, wherein the conversation prompt provides information about the target setting recommendation,
wherein the communications hardware is further configured to:
present the conversation prompt to the user; and
receive, in response to the conversation prompt, a user response,
wherein the language model circuitry is further configured to generate, using the user response a second output,
wherein the personalization recommendation circuitry is configured to update the target setting recommendation based on the first output and the second output from the language model circuitry,
wherein the apparatus is further configured to, in an instance in which executing the target setting recommendation requires modifying the set of personalization settings:
present an updated set of personalization settings to the user, wherein the updated set of personalization settings comprises the target setting and the target setting recommendation, and
in an instance in which the user confirms the updated set of personalization settings, update the set of personalization settings according to the target setting recommendation.

10. The apparatus of claim 9, wherein the personalization recommendation circuitry is further configured to determine, based on the first output and the second output from the language model circuitry, a profile setting, wherein the profile setting determines the set of personalization settings from among a plurality of sets of personalization settings.

11. The apparatus of claim 10, wherein the personalization update circuitry is further configured to, in an instance in which the profile setting differs from a currently active profile setting:
update the currently active profile setting to match the profile setting; and
update the set of personalization settings according to the profile setting.

12. The apparatus of claim 10, wherein the profile setting is an incognito profile setting and the personalization update circuitry is further configured to:
detect selection of the incognito profile setting; and
update the set of personalization settings so that personal information is not retained.

13. The apparatus of claim 10, wherein the profile setting is a sandbox profile setting, and personalization circuitry is further configured to:
detect selection of the sandbox profile setting; and
update the set of personalization settings so that personal information is retained only within a sandbox environment.

14. The apparatus of claim 9, wherein the initiating event data derives from a database, wherein the language model circuitry comprises a large language model.

15. The apparatus of claim 9, wherein the communications hardware is further configured to receive a user data update, wherein the user data update comprises a life event related to the user, wherein the initiating event data comprises details of the user data update.

16. The apparatus of claim 9, wherein the communications hardware is further configured to:
provide an incentive offer to the user, wherein the incentive offer is linked to the target setting recommendation; and
receive a user response to the incentive offer,
wherein the initiating event data comprises the incentive offer and the user response to the incentive offer.

17. A computer program product for customizing a set of personalization settings for a user, the computer program product comprising at least one non-transitory computer-readable storage medium storing software instructions that, when executed, cause an apparatus to:
receive initiating event data regarding an initiating event;
generate a first output using the initiating event data;
determine, based on the first output, a target setting from the set of personalization settings and a target setting recommendation, wherein the target setting and the target setting recommendation are related to the initiating event;
generate a conversation prompt, wherein the conversation prompt provides information about the target setting recommendation;
present the conversation prompt to the user;
receive a user response in response to the conversation prompt;
generate, a second output using the user response;
update the target setting recommendation based on the first output and the second output; and
in an instance in which executing the target setting recommendation requires modifying the set of personalization settings:
present an updated set of personalization settings to the user, wherein the updated set of personalization settings comprises the target setting and the target setting recommendation, and
in an instance in which the user confirms the updated set of personalization settings, update the set of personalization settings according to the target setting recommendation.

18. The computer program product of claim 17, wherein the storage medium further stores software instructions that, when executed, cause the apparatus to:
determine, based on the first output and the second output, a profile setting, wherein the profile setting determines the set of personalization settings from among a plurality of sets of personalization settings.

19. The computer program product of claim 18, wherein the storage medium further stores software instructions that when executed, cause the apparatus to, in an instance in which the profile setting differs from a currently active profile setting:
update, by the personalization update circuitry, the currently active profile setting to match the profile setting; and
updating, by the personalization update circuitry, the set of personalization settings according to the profile setting.

20. The computer program product of claim 18, wherein the profile setting is an incognito profile setting and wherein the storage medium further stores software instructions that when executed, cause the apparatus to:
detect selection of the incognito profile setting; and
update the set of personalization settings so that personal information is not retained.
